(19) United States
(12) Patent Application Publication
(10) Pub. No.: US 2003/0131943 A1
(43) Pub. Date: Jul. 17, 2003

(54) Apparatus and method for assembling absorbent garments

(76) Inventor: Douglas R. Frederisy, Alpharetta, GA (US)

Correspondence Address: Christopher C. Campbell, Esq., Hunton & Williams, Suite 1200, 1900 K Street, NW, Washington, DC, 20006-1109, US

(21) Appl. No.: 10/046,726

(22) Filed: Jan. 17, 2002

(51) Int. Cl. B26D 7/06; B32B 31/00

(52) U.S. Cl. 156/538; 83/98

(57) ABSTRACT

An apparatus and method for assembling absorbent garments are disclosed. The apparatus has a passage, which may be internal or external, having an upstream end and a downstream end. One or more orifices are positioned to provide a flow of air towards the downstream end of the passage. A series of parts is provided to the upstream end of the passage at a first spacing and velocity. As the parts travel along the passage, the air flow increases the spacing between the parts and the velocity of the parts to a second spacing and second velocity. The flow of air through the orifice or orifices may be regulated to control the second spacing and second velocity of the parts. The apparatus may be used to assemble parts onto a moving substrate positioned near the downstream end of the passage.

### FIELD OF THE INVENTION

The present invention generally relates to absorbent garment and textile manufacturing. In particular, it relates to an apparatus and method for using an air conveyance device to apply discrete parts to a substrate.

### BACKGROUND OF THE INVENTION

During the manufacture of many products, if often is desirable to apply a supply of discrete parts onto a substrate. For example, many parts of diapers and other absorbent garments are provided as discrete parts that are applied in a spaced-apart manner onto a moving substrate. The substrate may comprise a continuous web of material, a supply of spaced apart objects, a combination of webs and objects, and the like. The substrate also may be a conveyor belt or other conveying device. In the field of absorbent garment manufacturing, typical discrete parts include absorbent cores, transfer layers, adhesive tabs, and the like, and typical substrates to which these parts are applied include absorbent cores, topsheet webs, backsheet webs, chassis webs, conveyors and the like.

In many cases, the discrete parts may be formed from a continuous material supply that is severed into the discrete part form prior to being applied to the substrate. Such operations are sometimes referred to as a “cut and place” operations. Cut and place operations are often advantageous because the parts may be provided to the manufacturing line in a roll form or other form of continuous supply, which generally makes handling the material easier. Often, however, the material supply from which the parts are cut is provided at a slower rate, as measured in terms of linear feed rate, than the substrate to which the parts eventually are applied. Typically this is the case when the part's desired length (in the machine direction) is shorter than the substrate's length or, in the case in which the substrate is a continuous supply of material that is later severed into individual products, the length of the substrate corresponding to one product. Eventually, the parts must be accelerated to the speed of the substrate, and often it has been found to be desirable to employ a cut and place device that accelerates the parts to the speed of the substrate prior to depositing them onto the substrate in order to prevent misalignment of the parts or damage to the parts or to the substrate.

Current cut and place devices typically are operated such that their surface velocity matches either the speed of the parts as they are initially supplied, the speed of the moving substrate, or some intermediate speed. A typical cut and place device is disclosed, for example, in commonly assigned U.S. Pat. No. 5,415,716 issued to Kendall, which is incorporated herein by reference in its entirety. These devices comprise a vacuum conveyor that rotates with a surface speed close to the speed of the substrate. The vacuum conveyor slides against the material supply from which the parts are cut until each part is cut, at which time the severed part adheres to the vacuum conveyor.

Current cut and place devices have certain drawbacks. For example, when the parts or the substrate come into contact with a placing device having a different surface velocity they may be subjected to potentially harmful forces, such as impacts, friction, tension, compression, and the like. The parts and the web also may damage one another when they contact each other at different speeds, and the differential speed may complicate the joining of the two. In an effort to overcome the problems inherent in having differential speeds between the placing device and the parts or substrate, other known cut and place devices have employed mechanical linkages that pick up parts at one velocity and set them onto the substrate at the substrate's velocity. Such devices often are cumbersome, difficult to modify to provide different speeds, and require relatively high maintenance.

The absorbent garment industry has a particular need for cut and place devices, because absorbent garments, such as diapers, adult incontinence products, feminine care products, and the like, often are manufactured from continuous webs of material having a number of parts applied to them as discrete parts. These parts preferably are discrete in order to provide the desired structure and improved performance without incurring any more material costs than necessary.

It would be desirable to provide an improved method and system for cutting and placing parts onto a moving substrate that does not subject the parts or substrate to harmful differential surface speeds. It also would be desirable for such a system to be easily adapted to operate in different manufacturing lines and to operate at different speeds, positions and orientations. It would further be desirable for such a method and system to be inexpensive and easily maintained and suitable for use in many different applications. The present invention may be employed to provide these and other benefits.

These are just a few of the disadvantages of the prior art that the preferred embodiments seek to address. The foregoing description of certain materials, methods and systems with their attendant disadvantages in no way is meant to infer that the present invention excludes such materials, methods, and systems. Indeed, certain embodiments of the invention solve some of the aforementioned disadvantages and other disadvantages, yet may utilize the same or similar materials, methods and/or systems.

### SUMMARY OF THE INVENTION

The features of the invention generally may be achieved by an apparatus for assembling absorbent garments having a passage with an upstream end and a downstream end. One or more orifices are adapted to direct a flow of air towards the downstream end of the passage. A series of parts is provided to the upstream end of the passage at a first spacing and velocity. As the parts travel along the passage, the air flow increases the spacing between the parts and the velocity of the parts to a second spacing and second velocity.

A cutting device may be positioned near the upstream end of the passage to provide a supply of parts that are severed from a continuous part material supply. A moving substrate may be positioned near the downstream end to receive the parts as they exit the apparatus. In one embodiment, the velocity of the flow of air may be selected to be approximately equal the velocity of the moving substrate.

In various embodiments, the flow of air through the orifice of orifices may be regulated to control the second spacing and second velocity of the parts by manipulating the orifices or by using a regulator to adjust the air flow properties.

In various embodiments, the apparatus may be used to assemble parts such as foam panels, ribbons, sheets, yarns or strands.

In various other embodiments, the parts may be parts of an absorbent garment, and the substrate may be an absorbent garment subassembly.

In still other embodiments, the apparatus may further comprise a control system that is adapted to control the second spacing and second velocity. Such a control system may operate by detecting a value of at least one of the second speed and second spacing and to control at least one of the second spacing and second velocity based on the detected value.

### BRIEF DESCRIPTION OF THE DRAWINGS

FIG. 1 is cross sectional view of an embodiment of an internal air applicator of the present invention, showing the internal applicator depositing a part onto a moving substrate;

FIG. 2 is an isometric view of another embodiment of an internal air applicator of the present invention having a number of passages;

FIG. 3 is an isometric view of another embodiment of an internal air applicator of the present invention having a single rounded passage;

FIG. 4 is an isometric view of another embodiment of an internal air applicator of the present invention having a single rectilinear passage;

FIG. 5 is an isometric view of an embodiment of an external air applicator of the present invention, showing parts being severed by a cutting device;

FIG. 6 is a cross sectional view of another embodiment of an external air applicator of the present invention having an air knife orifice;

FIG. 7 is a cross sectional view of still another embodiment of an external air applicator of the present invention having an angled slot orifice;

FIG. 8 is a partially cut away side view of an embodiment of an upright external air applicator of the present invention applying parts to a substrate;

FIG. 9 is a partially cut away side view of an embodiment of an inverted external air applicator of the present invention applying parts to a substrate;

FIG. 10 is a partially cut away isometric view of an absorbent garment having a number of yarns disposed on the absorbent core by an embodiment of the present invention;

FIG. 11 is a partially cut away isometric view of an absorbent garment having a supplemental core layer disposed on the absorbent core by an embodiment of the present invention;

FIG. 12 is a partially cut away side view of various embodiments of the present invention being used with an absorbent core forming apparatus; and

FIG. 13 is a partially cut away side view of an embodiment of an external air applicator of the present invention being used with an two-step core forming apparatus.

### DETAILED DESCRIPTION OF THE PREFERRED EMBODIMENTS

As understood herein, “manufacturing line,” “processing line” and “line” refer to any manufacturing or assembly line. Such a processing line may operate substantially non-stop or intermittently, and may move in substantially one direction, or may operate in several directions. Such lines may have one or more substantially continuous webs of material that are substrates to which discrete parts are desired to be joined. For example, a main carrier web of material may serve as the substrate for constructing a series of garments, as parts comprising the garments are added to the main carrier web. Additional carrier webs may be used as substrates to create other parts or subassemblies that are added to the main carrier web. One or more material supplies may be fed into the manufacturing line to be cut into parts and placed on various locations of the substrates. The present invention may be used with any processing line to place parts onto substrates, and the following description is not intended to limit the scope of the application of the invention.

In embodiments of the invention in which a number of embodiments of the present invention are used simultaneously, such embodiments may be operated substantially independently of one another, or they may be partially or entirely integrally controlled by a single driving system having a relatively small number of partially or wholly-independent controllers. Such a system may be based on a modular system such as those disclosed in commonly assigned U.S. Pat. Nos. 5,492,591 and 5,383,988, both issued to Herrmann et al., and both of which are incorporated herein by reference in their entirety.

The “machine direction,” as used herein, is the primary direction in which material is traveling through the processing line at any given point. The material moving through the processing line generally originates from the upstream direction and moves in the downstream direction as it is processed. The “cross-machine direction” or “cross direction” is perpendicular to the machine direction and generally parallel to the plane of the material being processed. The cross machine direction generally corresponds to the width of the material being conveyed. The “z-direction” is orthogonal to the plane defined by vectors in the machine direction and cross machine direction, and generally corresponds to the thickness of the material being conveyed.

As used herein, “web” refers to any substantially continuous supply of material that is fed through a processing line. A web may comprise, for example, woven cloth, nonwoven material, foam, mesh, film, paper, tissue, thin plastics and elastics, and the like. The web may be a single layer of material, supplies of material joined in series, or an aggregation or laminate of materials, in which case the supplies of materials constituting the web may themselves be continuous or non-continuous, and may include discrete (i.e., non-continuous) objects distributed in a spaced-apart manner along the machine direction or cross-direction of the web. The web may be conveyed along the line by any means known in the art, such as by pinch rollers, vacuum drums, foraminous vacuum belts, and the like, or a combination of such devices. The conveyance means may be driven by interlinked or individual power transmission devices controlled independently or collectively by any type of drive control system.

As used herein, the term “part” refers to any discrete object that desired to be conveyed and deposited by an apparatus of the present invention. A part may be supplied to the processing line as a discrete object, or may be severed from a substantially continuous material supply, such as a web or other supply of material. Preferably, the parts are supplied as a continuous supply of sheet, yarn, fiber, or other material.

The term “substrate” refers to an object or objects onto which an apparatus of the present invention applies parts. The substrate may comprise a continuous web of material, a supply of spaced apart objects such as product assemblies or subassemblies, or a combination of webs and objects. Such webs and/or objects may be provided on a conveying device. The substrate also may be a conveyor belt or other conveying device to which the parts are applied directly.

As used herein, the terms “air” and “gas” refer to any compressible gaseous fluid. Both of these terms include regular atmospheric air, any substantially pure gaseous fluid, such as nitrogen gas, or blends of compressible gaseous fluids, whether compressed, heated, cooled, stored in liquid form, or otherwise treated or handled. An “air flow,” as used herein, is a relatively concentrated moving flow of any air/gas.

As used herein, the terms “absorbent garment” and “absorbent article” refer to devices that absorb and contain body fluids and other body exudates. More specifically, these terms refer to garments that are placed against or in proximity to the body of a wearer to absorb and contain various exudates discharged from the body. A non-exhaustive list of examples of absorbent garments includes diapers, diaper covers, disposable diapers, training pants, feminine hygiene products and adult incontinence products. Such garments may be intended to be discarded or partially discarded after a single use (“disposable” garments). Such garments may comprise essentially a single inseparable structure (“unitary” garments), or they may comprise replaceable inserts or other interchangeable parts. The embodiments of the invention described herein may be used in conjunction with a processing line that processes nonwoven materials and other materials into these and other absorbent garments. The present invention also may be used with other types of processing line, as will be evident to those skilled in the art based on the teachings herein.

For clarity, features that appear in more than one Figure have the same reference number in each Figure.

The present invention deals particularly with an air applicator that uses an air flow to place parts onto a moving substrate. The air applicator generally comprises a passage having an upstream end and a downstream end. The upstream end receives a series of parts, which may still be integral with a continuous part material supply as they enter the passage. One or more orifices, such as holes, slots and the like, are provided to direct an air flow towards the downstream end of the passage. The air flow conveys the parts to the downstream end, and, in doing so, increases the spacing between successive parts and increases the velocity of the parts.

The air applicator preferably accelerates the parts to have approximately the same velocity (i.e., within about 60%) as a moving substrate, located near the downstream end, onto which the parts are placed, however the part velocity at the downstream end may be substantially more or less than the substrate velocity. Ideally, the velocity of the parts is close enough to the velocity of the substrate that the parts and/or substrate are not damaged by contact with one another and the parts are consistently properly aligned in their proper place on the substrate without undesirable misalignment, wrinkling, stretching, tearing, or other defects. The air flow preferably also cushions the parts from harsh contact with surrounding surfaces or objects, such as the surfaces of the passage. By using the present invention, damaging forces and the incidence of defective placement may be reduced, thereby allowing the transfer and application of lighter, more delicate parts. A skilled artisan will be able to determine the proper degree to which the parts' velocities should match the substrate's velocity through routine experimentation in light of the teachings provided herein.

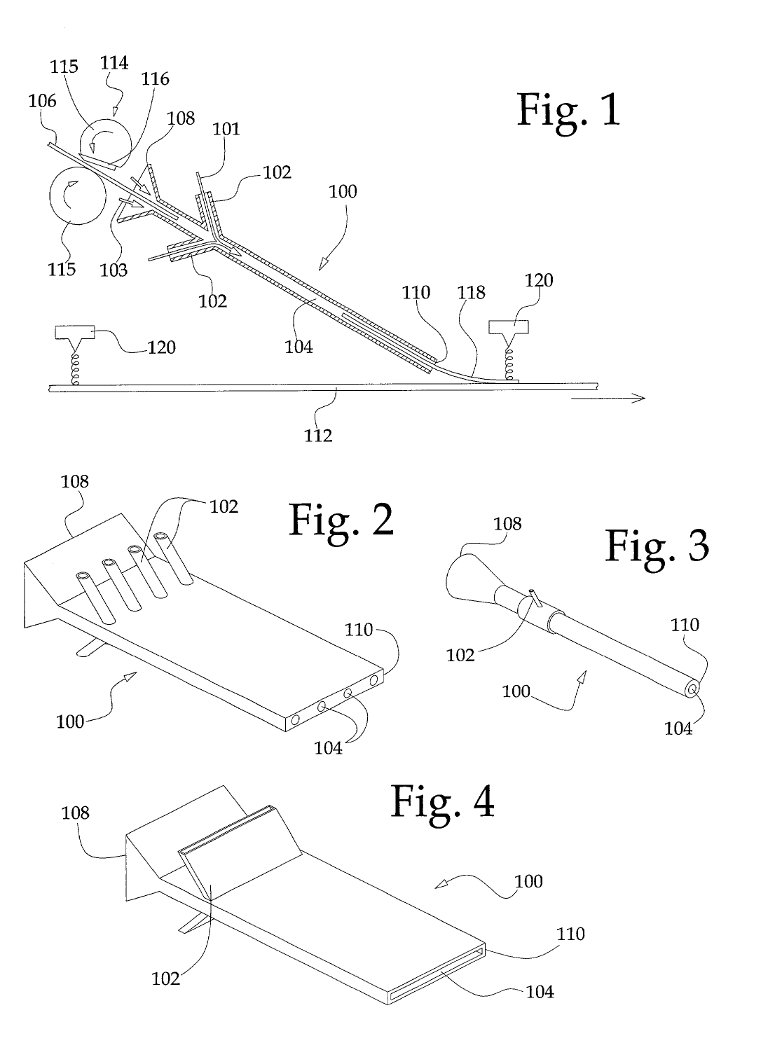

A first embodiment of an air applicator of the present invention is shown in FIG. 1, in which the air applicator comprises an internal air applicator 100. Internal air applicators 100 have a substantially enclosed passage 104 (i.e., a generally internal passage having relatively few openings). The internal air applicator 100 comprises one or more orifices 102 through which high pressure gas, such as compressed air, is injected into the passage 104. The passage 104 is adapted to receive parts 118 or a material supply 106 (from which parts 118 are severed) at an upstream end 108, and terminates at a downstream end 110. The orifices 102 are angled or oriented to direct an air flow 101 towards the downstream end 110.

The air flow 100 also may be directed towards the downstream end by using the “coanda effect,” which is a fluid dynamics phenomenon whereby fluids (including gaseous fluids) cling to nearby rounded profiles. To take advantage of the coanda effect, the passage 104 preferably should be necked down in a rounded fashion adjacent the orifices 104 and between the orifices 102 and the downstream end 110. A properly shaped “coanda passage” will cause the air to cling to the profile of the passage 104 and move towards the downstream end 110, even when the air initially flows out of the orifices 104 in a direction perpendicular to the downstream end. Those skilled in the art of fluid dynamics will be able to provide such a shape or profile to the passage 104 to generate the desired directional movement of the air flow 101.

The passage 104 may be straight or curved, and its downstream end 110 may be beveled, flared, rounded or otherwise shaped or treated to facilitate the exit of parts 118 therefrom.

A material supply 106, or a series of discrete parts 118, is supplied to the upstream end 108, which may be flared or otherwise shaped to correct any misalignment between the material supply 106 or parts 118 and the upstream end 108. The downstream end 110 preferably is located close to a substrate 112 to which parts 118 severed from the material supply 106 are to be applied.

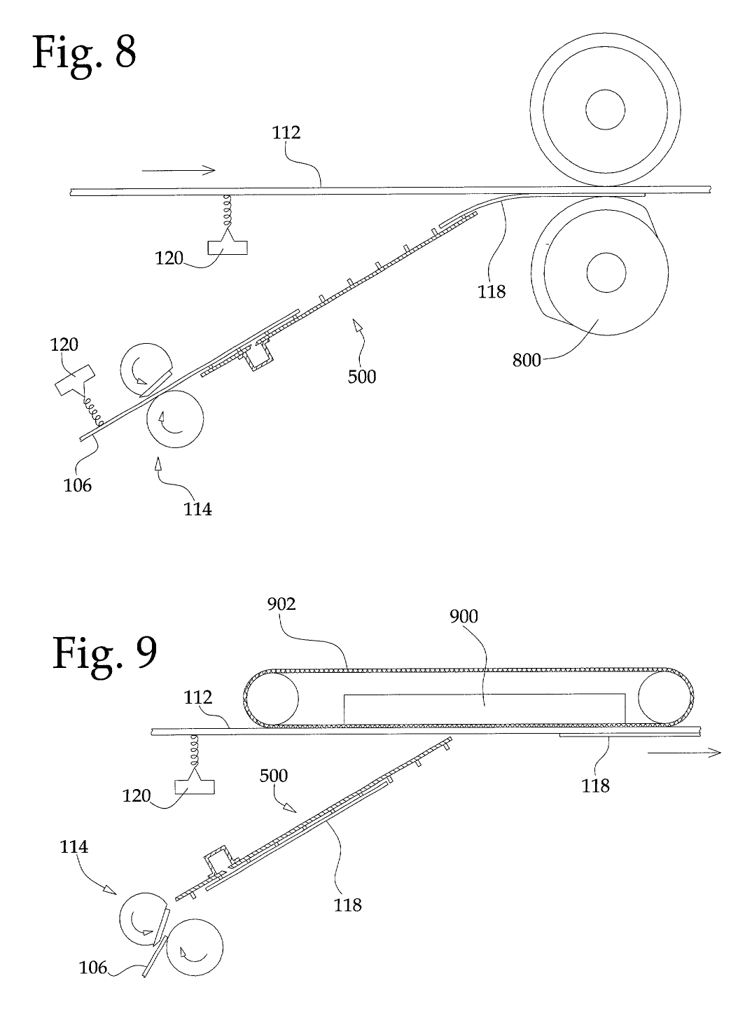

One or more adhesive applicators 120 may be used to coat the parts 118 and/or the substrate 112 with adhesive to form a bond therebetween. Commercially available adhesive applicators 120 include hot melt adhesive applicators available from Nordson Corporation of Norcross, Ga., or other applicators. Alternatively, the parts 118 may be joined to the substrate by any other suitable means, such as by ultrasonic bonding, heat bonding, and so on. Other devices, such as bump rolls (see FIG. 8 and the discussion thereof) also may be used to enhance or form a bond between the parts 118 and the substrate 112. These and other joining methods and devices are generally known in the art, and the suitability of the various joining methods will depend on the materials that comprise the parts 118 and the substrate 112. The present invention is not intended to be limited to the use of any particular joining method or device, and, indeed, the parts 118 may not be joined to the substrate 112 at all, as may be the case when the substrate 112 is another conveying device or when the part 118 is captured between the substrate 112 and another layer of material or object.

A cutting device may be positioned proximal to the upstream end 108 to sever the material supply 106 into discrete parts 118. The material supply 106 preferably extends into the passage 104 before it is severed into parts 118, as shown in FIG. 1, to ensure that the parts 118 severed therefrom are properly fed to the passage 104. In a preferred embodiment, the cutting device is a die knife 114. Die knives 114 generally comprise two counter-rotating drums 115, one of which has one or more blades 116 attached thereto. As the die knife 114 rotates, the blade or blades 116 sever the material supply 106, typically, by pinching the material supply 106 against the counter-rotating drum 115. Such die knives 114 are suitable for severing a variety of threads, yarns, sheets and other types of material, and generally are known in the art. The rotational speed, diameter, or blade spacing of the die knives 114 may readily be selected to provide parts 118 having the desired length, as will be understood by those skilled in the art.

The selection of a suitable cutting device generally depends on the composition of the material supply 106 and the desired cut quality. Other types of cutting device, such as laser cutters, hydraulic cutters, reciprocating blades and so on, also may be used with the present invention, and the present invention is not intended to be limited to any particular type of cutting device. Those skilled in the art will be able to select a proper cutting device without undue experimentation based on the teachings provided herein.

As high pressure gas exits the orifices 102 and forms an air flow 101 towards the downstream end 110, an additional flow of air 103 is pulled into the passage through its upstream end 108, a phenomenon often referred to as eduction. The volume of the additional flow of air 103 may greatly exceed the volume of the air flow 101 generated by the gas that is injected into the passage 104 through the orifices 102. The flow of air in the passage 104 (i.e., gas or air flowing from the orifices 101 and/or the upstream end 103) pull the material supply 106 into the passage 104, and force the severed parts 118 out of the downstream end 110.

Commercially available eductors may be used with the present invention to generate an air flow. Exemplary eductors are available from EXAIR Corporation of Cincinnati, Ohio. Eductors have no moving parts, making maintenance relatively inexpensive. Furthermore, such devices may be adapted to provide relatively rapid-response control over operational outputs, such as part speed and spacing, by regulating operating parameters such as the pressure of the gas entering through the orifices 102.

The flow of air in the internal air applicator 100 pulls each part 118 away from the material supply 106 as they are severed therefrom, spacing the parts 118 from one another as they are conveyed though the passage 104. Preferably, the spacing between successive parts 118 matches their desired spacing as they are applied to the substrate 112. The flow of air also accelerates the parts 118 to a velocity at the downstream end 110 that is greater than the velocity of the material supply 106 (or parts 118) entering the upstream end 108 of the internal air applicator 100. The velocity of the parts 118 preferably is close enough to the velocity of the substrate 112 that the parts 118 are not misaligned and the parts 118 and substrate 112 are not damaged as they contact one another. In one embodiment, the velocity of the flow of air is selected to match the velocity of the substrate 112. Furthermore, the flow of air may help cushion the parts 118 from hard contact with the internal walls of the passage 104.

The spacing and velocity of the parts 118 may be adjusted by modifying various features of the air applicator, such as by changing the length and width of the passage 104, the pressure and volume of the gas entering through the orifices 102, and the volume of air entering the upstream end 108. Additional features of the internal air applicator 100 also may be modified to affect the spacing and speed of the parts 118, as will be understood by those skilled in the art. Of these features, the gas pressure at the orifices 102 may be modified with relative ease using a conventional pressure regulator, to thereby regulate the properties (e.g., pressure, mass or volume flow rate, etc.) of the air flow. Such a pressure regulator may be controlled by a control system that measures the spacing and speed of the parts 118 to provide nearly instant feedback to adjust the gas pressure to thereby maintain the desired part speed and spacing. Those skilled in the art will be able to tune these and other parameters of the internal air applicator 100 to provide the desired part spacing and part velocity based on the teachings provided herein.

Additional features may be added to the internal air applicator 100 to provide further benefits or control to the invention. For example, bleed valves may be added to the passage 104 to selectively vent the air flow, friction brakes may be added to slow the parts 118, or supplemental orifices may be provided between the orifices 104 and the downstream end 110 or upstream end 108 to further propel, space or accelerate the parts 118. Other useful features will be apparent to those skilled in the art based on the teachings herein.

Various embodiments of the internal air applicator 100 may be adapted to convey different types of part 118, such as ribbons, fibers, yarns or sheets. In order to be conveyed by the air applicator, the parts 118 should be rigid enough to prevent substantial deformation by the air and gas flows. Parts 118 that lack the necessary rigidity may buckle, fold or otherwise deform such that they block the air flow or otherwise can not be conveyed or applied to the substrate 112 in a controlled manner. The tendency of a part 118 to buckle or fold may be counteracted to some degree by constraining the parts 118 by the interior walls of the passage 104, and so it may be desirable for the passage 104 to be only slightly larger than those parts 118 that might be difficult to convey effectively.

A number of parts 118 may be placed simultaneously onto a substrate 112 by providing an internal air applicator 100 having a number of passages 104, each with its own orifice or orifices 102, such as the embodiment shown in FIG. 2. Alternatively, a number of individual internal air applicators 100, as shown in FIG. 3, may be placed side-by-side, staggered or in any other relationship to place a number parts 118 on a substrate 112 in their desired locations. One or more cutting devices may be used in conjunction with an internal air applicator 100 or internal air applicators 100 that are used to provide multiple parts 118. For example, a single die cuter 114 may be used to cut a number of material supplies 106 that feed into a number of passages 104.

Internal air applicators 100 of the present invention may be oriented at any angle relative to the ground, and may be angled relative to the substrate 112 to dispose the parts 118 at an angle relative to the machine direction of the substrate 112. The passage 104 may be extended away from the cutting device to reach into contained or congested portions of the processing line. The passage 104 also may be curved, and may be constructed, at least in part, from a flexible material to allow adjustments to the location of the downstream end 110. In one embodiment, a flexible portion of the passage 104, or the entire internal air applicator 100, may be actuated to conform to movements of the substrate 112 or to provide a patterned disposition of parts 118 onto the substrate 112. The substrate 112 may be horizontal, as shown, or angled relative to the ground.

The embodiments shown in FIGS. 2 and 3 have generally circular passages 104 that may be suitable for disposing a number of types of yarn or thread parts 118 onto a substrate 112. Another embodiment of an internal air applicator 100, shown in FIG. 4, may be adapted for applying ribbon or sheet parts onto a substrate 112 by having a narrow slot passage 104. Passages 104 having other shapes may be employed to convey these and other parts 118, as will be understood by those skilled in the art. An embodiment having multiple passages 106, such as that shown in FIG. 2, also may be adapted to have a number of different passage shapes, such as rounded and rectilinear passages, for simultaneously conveying parts 118 having different shapes or structures. Other variations on the internal air applicator 100 will be apparent to those skilled in the art based on the teachings herein.

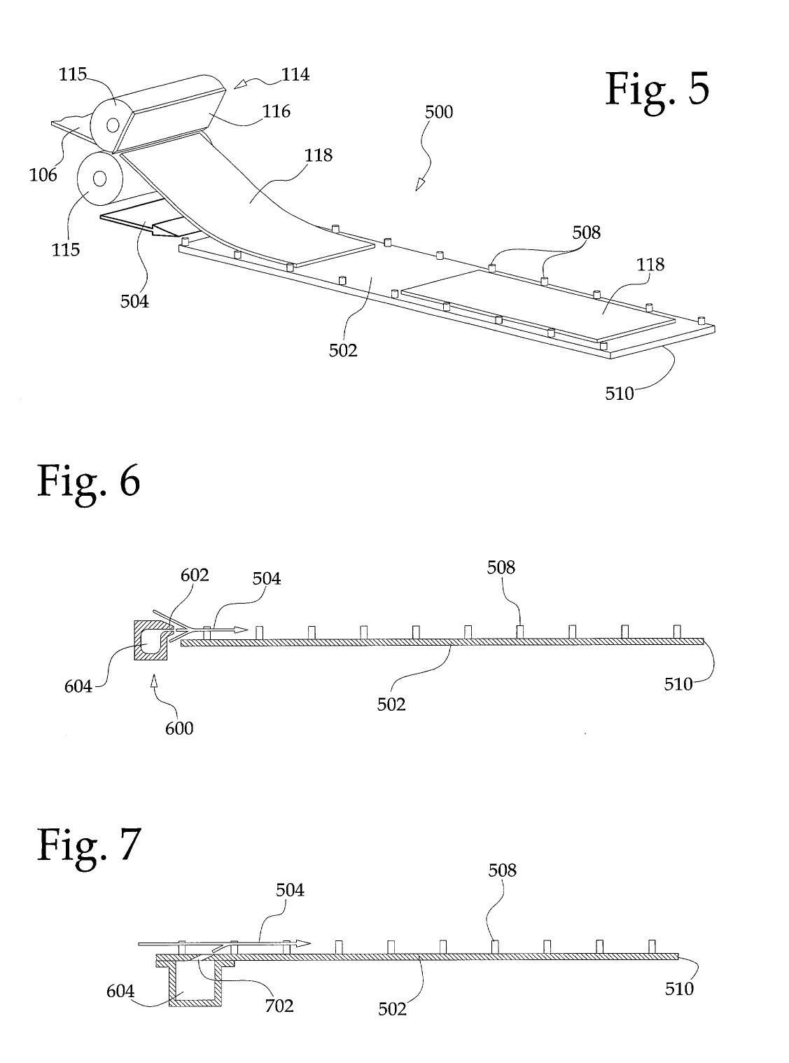

Referring now to FIG. 5, in another preferred embodiment of the present invention, the air applicator comprises an external air applicator 500. External air applicators 500, in contrast with internal air applicators 100, do not have a substantially enclosed passage 104 for conveying the parts 118. Instead, external air applicators 500 use an open passage that is defined, at least on one side, by a guide plate 502. An air flow 504 is directed between the material supply 106 and the guide plate 502 in a direction approximately parallel with the surface of the guide plate 502, and towards the downstream end of the guide plate 502, which terminates at a downstream edge 510. The relatively high velocity air flow 504 forms a vacuum between the material supply 106 and parts 118 severed therefrom and the guide plate 502, causing the material supply 106 and parts 118 to be attracted to the guide plate 502 (a phenomenon often referred to as the Bernoulli effect), while simultaneously maintaining an air cushion between the material supply 106 and parts 118 and the guide plate 502. This attraction force holds the parts 118 close to the surface of the guide plate 502, even to the extent that some parts 118 may be properly conveyed when positioned below the guide plate 502 (relative to the ground) instead of above it without escaping from the air flow 504 (see FIG. 9 and the discussion thereof). The guide plate 502 forms, in function, an open channel passage that conveys the parts 118 in a manner similar to the substantially enclosed passage 104 of the internal air applicator 100.

The air flow 504 drives the parts 118 to the downstream edge 510 of the guide plate 502. A number of guide pins 508 or rails preferably are located on the guide plate 502 along either side of the material supply 506 and parts 118 to help contain the material supply 506 and the parts 518 severed therefrom on the desired path. Like the internal air applicator 100 described herein, the external air applicator preferably is operated in conjunction with a cutting device such as a rotating die knife 114 comprising one or more blades 116 and a counter-rotating anvil roll 115, or any other suitable cutting device.

The air flow 504 may be provided to the external air applicator 500 by a number of different devices. Preferably, the air flow 504 is provided by an air knife 600, as shown in FIG. 6. Air knives 600, such as those available from EXAIR Corporation, provide a sheet-like laminar flow of air by passing a flow of air or gas through one or more orifices 602 from a pressurized source such as a pressure chamber 604. Preferably, the orifices 602 are slit-shaped openings, but other types of air knife 600 may use a number of holes, rather than a slit. The air or other gas that emerges from the orifices 602 entrains a relatively large amount of air from the surrounding atmosphere, so that the air flow 504 produced by the air knife 600 may have a much greater total volume than the volume of gas or air passing through the orifice 602. The air knife 600 preferably is positioned at the upstream end of the guide plate 502 and oriented such that the air flow 504 runs parallel to the guide plate's surface. An air knife 600 used with the present invention preferably also is adjustable mounted so that its position and angle relative to the guide plate 502 may be easily modified. The characteristics of the air flow 504 produced by such air knives may be adjusted by shimming the orifice 602 to make it narrower or wider, adjusting its angle and position relative to the guide plate 502, adjusting the pressure of the air in the pressure chamber 604, modifying the shape of the air knife (particularly in the region around the orifice 602), and by other methods as will be under stood by those skilled in the art based on the teachings herein.

Referring now to FIG. 7, an air flow 504 also may be provided by passing air through orifices comprising one or more angled slots 702 in the surface of the guide plate 502. The angled slots 702 preferably are angled towards the downstream edge 510 to direct the air flow 504 in that direction. The contour of the angled slots 702, particularly at the point where the angled slots 702 merge with the surface of the guide plate 502, may be tailored to further compel the air flow 504 towards the downstream edge. For example, a gentle rounded transition between the angled slot 702 and the surface of the guide plate 502 may draw the air flow 504 to the downstream edge 510 by the coanda effect, as described elsewhere herein. High pressure air or other gas may be provided to the slots 702 by affixing a pressure chamber to the back side or end of the guide plate 502 or by any other suitable method, as will be apparent to those skilled in the art from the teachings provided herein.

As with the internal air applicator 100, the external air applicator 500 of the present invention preferably is adapted to provide parts 118 at a desired speed and spacing as they exit past the downstream edge 510 so that they may be properly positioned onto a moving substrate 112. The speed and spacing may be adjusted by modifying the pressure, size, direction or flow rate of the gas that creates the air flow 504. Additional adjustments may be made by adjusting the angle and orientation of the external air applicator 500. The length of the guide plate 502 also may be modified to adjust the speed and spacing of the parts 118. The overall length of the guide plate may be limited by the ability of the air flow 504 to convey the parts 118, which generally is a function of the features of the parts 118 being conveyed and the initial strength, orientation and concentration of the air flow 504. These and other modifications will be apparent to those skilled in the art based in the teachings provided herein and with routine experimentation with the present invention, and a skilled artisan will be able to employ an external air applicator 500 without undue experimentation.

The parameters of the external air applicator 500 may be adjusted to allow the conveyance of a variety of different parts 118 having a number of different constructions and materials. The parts 118 should be rigid enough to be carried by the air flow 504 without buckling, folding, or escaping from the proximity of the guide plate's surface. Generally, relatively light and rigid materials are suitable for use with an external air applicator 500, however if the parts 118 are too light, turbulent air around the device may cause the parts to escape. In addition, relatively flexible parts 118 may require a shorter guide plate 502, as such parts may tend to escape from the air flow 504 sooner than relatively rigid parts 118. A shroud (not shown) may be placed around the external air applicator 500 to reduce the amount of potentially disruptive surrounding air currents contacting the parts 118 as they are being conveyed. Additional guides, such as a number of parallel wires or bars (not shown) oriented along the length of the guide plate 502, also may be used to capture the material supply 106 and parts 118 within the proximity of the guide plate's surface. Supplemental air flows may be provided between the air knife 600 or angled slots 702 and the downstream edge 510 to enhance the performance of the external air applicator 500. Other air flow modulating devices, such as bleed orifices, vanes, and surface treatments, also may be applied to the guide plate 502 to enhance performance.

An external air applicator 500 of the present invention may be used in a number of orientations. In the embodiment of the invention shown in FIG. 8, an external air applicator 500 may be positioned so that the parts 118 are between the guide plate 502 and the substrate 112. A portion of the guide plate 502 near the downstream edge 510 may be curved or contoured to facilitate the joining of the parts 118 to the substrate 112. In this embodiment, the air flow 504 operates against gravity to lift each part into contact with the substrate 112. If desired, an adhesive applicator 120 may coat the material supply 106 and/or the substrate 112 with adhesive to join the parts 118 to the substrate 112. In addition, a bump roll 800, such as are well known in the art, may be used to press each part 118 against the substrate 112 to improve the bond between the two. Other joining devices, such as ultrasonic bonders, heat bonders and the like, also may be used to join the parts 118 to the substrate 112, if desired. In an embodiment in which the parts 118 are located between the guide plate 502 and the substrate 112, the substrate 112 may be horizontal, as shown in FIG. 8, or angled relative to the ground. The external air applicator 500 also may be inverted (i.e., upside-down) relative to the orientation shown in FIG. 8.

In another embodiment of the invention shown in FIG. 9, the external air applicator 500 may be positioned so that the guide plate 502 is between the parts 118 and the substrate 112. In the embodiment of FIG. 9, the external air applicator 500 carries the parts 118 upwards to join the substrate 112. In a similar embodiment shown in FIG. 5, the parts 118 may be conveyed downward to join the substrate 112. The substrate 112 also may be oriented at an angle relative to the ground.

In the embodiment of FIG. 9, it may be necessary to evacuate the air flow 504 as it impinges on the substrate 112 to prevent the air flow 504 from rebounding off of the substrate 112 and displacing the parts 118. The air flow 504 may be evacuated by providing a vacuum chamber 900 having an open area facing the air flow 504 on the opposite side of the substrate 112. In such an embodiment, the substrate 112 should be air permeable to allow the air flow 504 to pass into the vacuum chamber 900. To prevent the substrate 112 from being drawn into the vacuum chamber 900, the vacuum chamber may have a smooth foraminous surface over which the substrate 112 slides, or may be surrounded by a foraminous conveyor 902 that carries the substrate 112.

In an embodiment in which the guide plate 502 is positioned between the parts 118 and the substrate 112, an adhesive applicator 120 may be used to apply adhesive to the substrate 118 prior to joining it with the parts 118. Alternatively, or in addition, another adhesive applicator (not shown) may apply adhesive to the parts 118 after they are brought into contact with the substrate 112. Other joining devices, such as ultrasonic bonders, heat bonders and the like, also may be used to join the parts 118 to the substrate 112, if desired. A bump roll 800, as described elsewhere herein or otherwise as known in the art also may be used to press each part 118 against the substrate 112 to improve the bond between the two layers.

An air applicator of the present invention preferably is controlled so that it places each part 118 at the desired location on the substrate 112. In a preferred embodiment, the gas pressure at the orifice(s) 102, 602, 702 is regulated by a central processing unit (CPU) that uses feedback control to adjust the speed and spacing of the parts 118. The CPU detects and/or calculates the position and/or velocity of the parts 118, either by direct measurement during their movement through the air applicator or by sampling the positions of one or more of the parts 118 after they have been applied to the substrate 112. These readings may be used to modulate the pressure or volume of the gas entering through the orifices 102, 602, 702 to regulate the speed and spacing of the parts 118. Generally, higher pressures and flow rates will increase the speed and spacing. Optical, electrical, mechanical, or other known sensing devices may be used to provide feedback information to the CPU. The CPU 404 also may be adapted to detect, calculate or receive information regarding the substrate's position and velocity. Such a control system may be particularly useful to provide parts 118 to the proper location on the substrate 112 during transitional operation phases, such as during start-up, shutdown and speed changes of the processing line. The programming and construction of such CPUs are generally known in the art, and a skilled artisan will be able to employ such a system to control an air applicator of the present invention without undue experimentation based on the teachings provided herein.

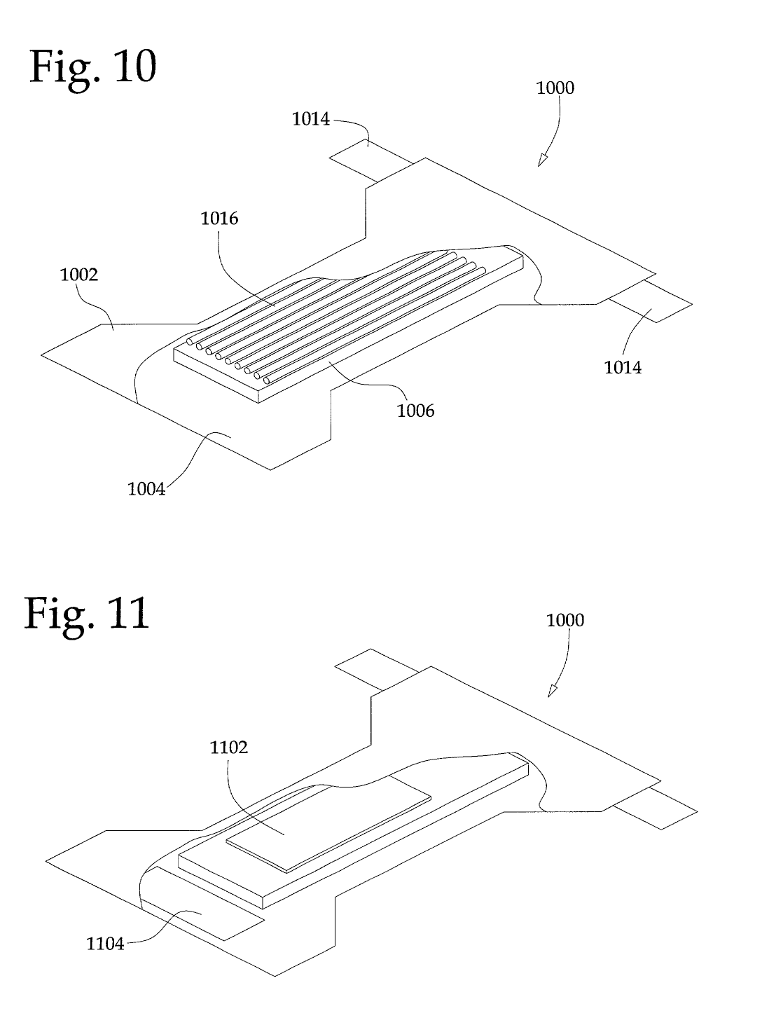

Referring now to FIGS. 10 and 11, embodiments of the present invention may be particularly useful in the absorbent garment producing industry. Absorbent garments typically contain a number of parts that are attached to a substantially continuous moving web of substrate material. Embodiments of the present invention may be used to place many of these parts onto the desired substrates.

Absorbent garments generally comprise a liquid pervious topsheet layer 1002, a liquid impervious backsheet layer 1004, and an absorbent core 1006 disposed between the topsheet 1002 and the backsheet 1004. In order to fit the garment on a wearer, portions of the topsheet 1002 and/or backsheet 1004 may be adapted to provide the garment with a pant-like structure, or a topsheet/backsheet/core assembly may be applied to a chassis layer that forms a pant-like structure. The garment may be held to the wearer by providing a continuous waist belt, or by using an openable waist having fasteners 1014 to hold the waist together. In some cases, the absorbent garment may not be designed to wrap around a wearer's waist, as with many feminine care products, but may instead be contained within an undergarment or otherwise held in place against a wearer. A number of other absorbent garment configurations also may be used successfully, and the present invention may be used in the manufacture of absorbent garments having any such configuration. The general construction of absorbent garments is described in greater detail in U.S. Pat. Nos. 6,068,620 to Chmielewski, 5,931,825 to Kuen et al. and 5,685,874 issued to Buell et al., all of which are incorporated by reference herein in their entirety.

In order to manufacture absorbent garments, one or more layers of material, parts or subassemblies may be provided into the manufacturing line as a substrate to which other layers and parts are attached, thereby forming a continuous supply of connected garments or subassemblies that are connected by a common substrate web. Later in the assembly, the substrate and any subassemblies, layers or parts attached thereto may be severed from the continuous supply of garment bodies to form individual garments, and further processing may be done to the individual garments. Other assembly procedures are known in the art, and the present invention is not intended to be limited to any particular assemble procedure.

Various additional parts preferably are placed on each absorbent garment 1000. For example, performance-enhancing yarns 1016, fibers, additional layers, such as supplemental core layers 1102, fasteners 1014 and appliques 1104 all may be desirable additions to absorbent garments 1000, as shown in FIGS. 10 and 11, respectively. Additional parts 118, such as yarns 1016 and supplemental core layers 1102, often increase the cost of the absorbent garment, and so it is typically desirable to use as little material as possible for such parts and to position the these parts only where they will provide the greatest benefit. Various embodiments of the present invention may be adapted to operate in absorbent garment manufacturing lines to place these and other parts 118 onto absorbent garment assemblies.

The use of bundles of fibers or yarns 1016 in absorbent garments is disclosed, for example, in U.S. Statutory Invention Report No. H1,511 to Chappell et al., which is incorporated herein by reference in its entirety. It is difficult to perform cut and place operations with these parts 118 because yarns 1016, fibers and fibrous bundles do not adhere well to the vacuum conveyors, such as vacuum transfer drums, that are commonly used by cut and place devices. Mechanical grips may be employed to hold the yarns 1016, or other strand-like parts, but such devices may be relatively expensive, complex, and difficult to maintain. An internal air applicator 100 of the present invention provides a relatively inexpensive and accurate way of providing cut and place operations with yarns 1016, and the like.

Supplemental core layers 1102, such as fluid handling layers, transfer layers, storage layers, acquisition layers, wicking layers and the like generally are known in the art of absorbent garment design and construction. Other parts 118 that may be deposited onto an absorbent garment include fasteners 1014, labels, appliques (decorative inserts) and so on. The design or selection of such parts 118 often are dictated by the material strength of the part 118 that is to be applied to the garment 1000. For example, the density of a nonwoven acquisition layer may be selected to be strong enough to withstand the forces of a conventional cut and place device, even though this density may be greater than desired from a product performance standpoint. As another example, certain foam materials may be too porous or brittle to be conveyed by conventional cut and place devices, so less desirable but more durable foam materials may be used instead. An internal air applicator 100 or external air applicator 500 may be used to apply foam panels and other such brittle, light and/or porous materials, in addition to conventional materials, without damaging the parts 118 because the air flow 504 provides a relatively even distribution of force across the entire surface of each part 118 as it conveys them to the substrate 112.

In a preferred embodiment, one or more internal air applicators 100 may be used to apply one or more yams 1016, fibers, or fibrous bundles to the top or bottom surface of the absorbent core 1006, as shown in FIG. 10, to the topsheet 1002 or backsheet 1004, or to other locations on the absorbent garment 1000. In another preferred embodiment, one or more internal or external air applicators 100, 500 may be used to apply fasteners 1014, appliqués 1104 or other ribbon-like or sheet-like parts 118 to the garment 1000. In still another preferred embodiment, an internal air applicator 100, or more preferably an external air applicator 500 may be used to apply supplemental core layers 1102 to the garment 1000. In a preferred embodiment, the supplemental core layers 1102 comprise foam panels. Foam materials, plastic fasteners and yarns are particularly suited for application by embodiments of the present invention because such parts 118 may be relatively rigid compared to other parts of the garment 1000, facilitating their conveyance by an air applicator without folding, buckling or otherwise deforming.

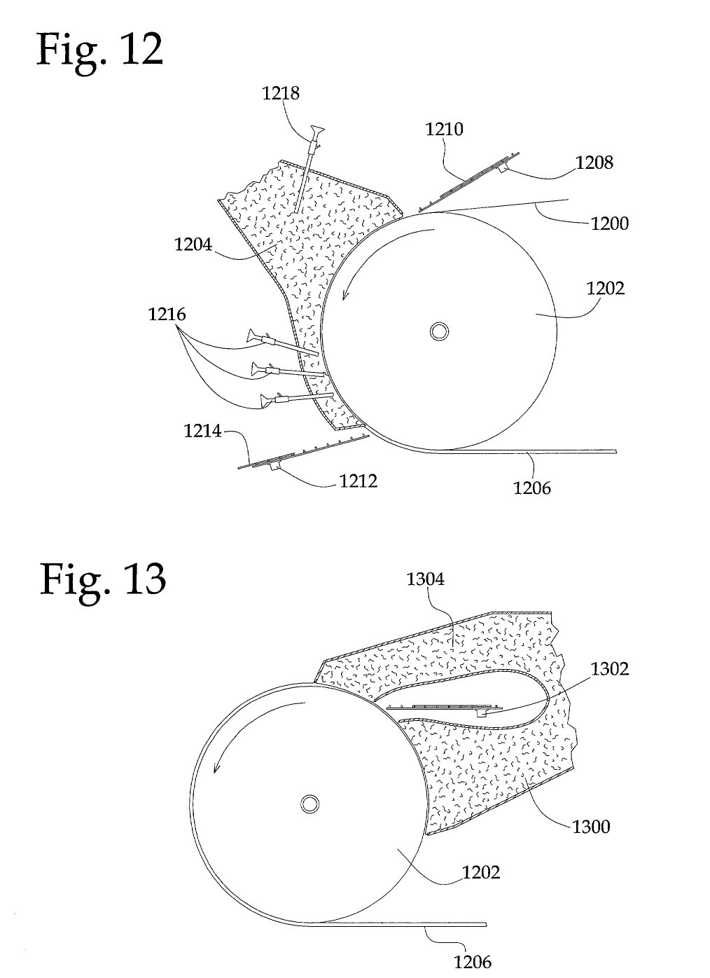

Embodiments of the present invention may be adapted to operate in different positions on an absorbent garment manufacturing line. For example, as shown in FIG. 12, a number of air applicators may be used during the formation of absorbent cores 1016. In the embodiment of FIG. 12, a tissue supply 1200 is conveyed by a vacuum drum 1202 into a core forming chamber 1204, in which particulate and fibrous material that form the absorbent cores 1006 are pulled onto the tissue supply 1200 by a vacuum in the vacuum drum 1202. A typical fibrous and particulate materials for absorbent cores 1006 include fluff pulp and superabsorbent polymer, respectively, as are discussed in more detail in U.S. Pat. Nos. 6,068,620, 5,931,825 and 5,685,874, which have been incorporated by reference herein. A continuous supply of core material 1206 emerges from the core forming chamber 1204, at which point further processing may occur to prepare the continuous core supply for integration into an absorbent garment. Such core forming devices are well known in the art, and the description of the use of embodiments of the present invention with this type of core forming devices shall not be understood to limit the present invention.

The present invention may be used to enhance the properties and performance of absorbent cores formed by such a process in a number of ways. For example, a first external air applicator 1208 may be positioned to deposit a first supply of additional layers 1210 onto the tissue supply 1200 before the tissue supply 1200 enters the forming chamber 1204. A second external air applicator 1212 may be positioned at the exit of the forming chamber 1204 to deposit a second supply of additional layers 1214 onto the other side of the absorbent core 1006 after it is formed in the forming chamber 1204. In addition, a number of internal air applicators 1216 may be positioned inside the forming chamber 1204 to deposit yarns, strands of core reinforcing material, or strands or ribbons of absorbent material, supplemental core layer material, or the like into the absorbent core 1006. These internal air applicators 1216 may be oriented to provide their parts 118 having a bias in the machine direction, cross machine direction or the z-direction. Another internal air applicator 1218 may be used to distribute discrete parts 118, such as fibers, yarns or ribbons of performance-enhancing material, into the blending mix of absorbent core material to be randomly distributed in the fibrous matrix of the absorbent core. Parts 118 deposited by the air applicators 1208, 1212, 1216, 1218 may be held in place by being captured within the fibrous matrix of the absorbent core material or by the use of adhesives or other joining techniques.

In another embodiment, an example of which is shown in FIG. 13, an air applicator may be used with a two-step core forming apparatus to construct absorbent cores 1006 having two fibrous absorbent layers with an intermediate supplemental core layer 1102. In the embodiment of FIG. 13, a vacuum drum 1202 rotates to collect core material as its surface passes by a first core forming chamber 1300. In this embodiment (or other embodiments, such as the one shown in FIG. 12) the tissue supply 1200 may be omitted, and the core material may be deposited directly onto the surface of the vacuum drum 1202. After having a first layer of core material deposited on its surface, the vacuum drum rotates past an air applicator 1302, such as an external air applicator 500, that places a supply of discrete parts 118 onto the surface of the first layer of core material. The vacuum drum then rotates to a second core forming chamber 1304, where a second layer of core material is deposited to partially or wholly encase the discrete parts 118. The second core forming chamber 1304 may be joined with the first core forming chamber 1300, as shown, or may be an entirely separate chamber. Air applicators are particularly suited to this operation because they are able to reach into relatively limited spaces, where conventional cut and place devices using rotating assemblies would not fit.

Embodiments of the present invention also may be used to attach other parts 118 to other substrates 112, as will be evident to those skilled in the art in light of the present teaching, and it will be understood that the invention is not limited to the applications disclosed herein.

It is anticipated that the present invention will provide a number of benefits over conventional cut and place devices that are used in conjunction with absorbent garment processing lines. For example, air applicators of the present invention may provide convenient adjustable control over the speed and spacing of successive parts that are to be applied to a substrate, in contrast to conventional cut and place devices that often require retooling or extensive adjustment to operate at different speeds. Air applicators of the present invention also may be used to convey relatively delicate or brittle parts that may be broken or damaged by conventional cut and place devices. Air applicators of the present invention also may be used in compact spaces. Still further, air applicators of the present invention may be adapted to provide a variety of different part types, such as yarns and fibers, that may be difficult to convey using conventional cut and place devices. Air applicators of the present invention have few or no moving parts, reducing maintenance costs and breakdowns, and may require relatively little energy. Air applicators also may be operated at high speeds, and it is anticipated that the present invention will operate in conjunction with an absorbent product processing line that produces more than 1000 absorbent garments per minute. Other uses and advantages of air applicators of the present invention will be evident to those skilled in the art based on the teachings provided herein.

The explanations herein of the theoretical mode of operation of the various embodiments of the present invention are provided for clarity only, and the present invention is not intended to be limited to the theories of operation described herein. Other theories or modes of operation may explain or influence the operation of the present invention.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

I claim:

1. An air applicator for placing a series of parts onto a substrate, the air applicator comprising:
a passage having an upstream end and a downstream end opposite the upstream end; and
one or more orifices adapted to direct an air flow towards the downstream end;
wherein the air applicator increases the spacing between successive parts from a first spacing at the upstream end to a second spacing at the downstream end, and increases the velocities of the parts from a first velocity at the upstream end to a second velocity at the downstream end.

2. The air applicator of claim 1, further comprising a cutting device disposed proximal to the upstream end; said cutting device being adapted to sever parts from at least one material supply.

3. The air applicator of claim 2, wherein the cutting device is a die cutter.

4. The air applicator of claim 1, further comprising a moving substrate onto which the parts are applied, the moving substrate being disposed proximal to the downstream end.

5. The air applicator of claim 4, wherein the moving substrate is a material web, a supply of discrete objects, or a conveying device.

6. The air applicator of claim 4, wherein the second velocity is approximately equal to the velocity of the moving substrate.

7. The air applicator of claim 1, wherein the one or more orifices may be manipulated to adjust the air flow properties.

8. The air applicator of claim 1, further comprising a regulator adapted to control properties of the air flow.

9. The air applicator of claim 1, wherein the parts are foam panels, ribbons, sheets, yarns or strands.

10. The air applicator of claim 1, wherein the upstream end comprises a splayed opening.

11. The air applicator of claim 1, further comprising:
a pressure regulator adapted to control the pressure of air entering the one or more orifices; and
a control system adapted to control the pressure regulator to thereby control the second spacing and second velocity.

12. The air applicator of claim 11, wherein the control system is further adapted to detect a value of at least one of the second speed and second spacing and to control at least one of the second spacing and second velocity based on the detected value.

13. An internal air applicator for placing a series of parts onto a substrate, the internal air applicator comprising:
a substantially enclosed passage having an upstream end and a downstream end opposite the upstream end; and
one or more orifices adapted to direct an air flow towards the downstream end;
wherein the internal air applicator increases the spacing between successive parts from a first spacing at the upstream end to a second spacing at the downstream end, and increases the velocities of the parts from a first velocity at the upstream end to a second velocity at the downstream end.

14. The internal air applicator of claim 13, wherein the substantially enclosed passage has a rounded profile.

15. The internal air applicator of claim 13, wherein the substantially enclosed passage has a rectilinear profile.

16. The internal air applicator of claim 13, further comprising a moving substrate onto which parts are applied, the moving substrate being disposed proximal to the downstream end.

17. The internal air applicator of claim 16, wherein the moving substrate comprises absorbent garment subassemblies and the parts comprise yarns.

18. The internal air applicator of claim 13, further comprising a regulator adapted to control properties of the air flow.

19. The internal air applicator of claim 13, wherein the one or more orifices comprise an eductor.

20. The internal air applicator of claim 13, wherein the substantially enclosed passage is a coanda passage.

21. An absorbent garment comprising:
a topsheet;
a backsheet;
an absorbent core disposed between the topsheet and backsheet; and
one or more yarns assembled to the garment using the internal air applicator of claim 13.

22. An external air applicator for placing a series of parts onto a substrate, the air applicator comprising:
a guide plate having an upstream end and a downstream end opposite the upstream end, the guide plate defining an open passage; and
one or more orifices adapted to direct an air flow towards the downstream end;
wherein the external air applicator increases the spacing between successive parts from a first spacing at the upstream end to a second spacing at the downstream end, and increases the velocities of the parts from a first velocity at the upstream end to a second velocity at the downstream end.

23. The external air applicator of claim 22, further comprising guide rails disposed on the guide plate on either side of the open passage and extending at least partly between the upstream end and the downstream end.

24. The external air applicator of claim 22, further comprising one or more guide pins disposed on the guide plate on either side of the open passage.

25. The external air applicator of claim 22, further comprising rows of two or more guide pins disposed on the guide plate on each side of the open passage.

26. The external air applicator of claim 22, wherein the one or more orifices comprise angled slots through the guide plate.

27. The external air applicator of claim 22, wherein the one or more orifices comprise an air knife.

28. The external air applicator of claim 27, wherein the air knife is adjustably mounted.

29. The external air applicator of claim 22, further comprising a regulator adapted to control properties of the air flow.

30. The external air applicator of claim 22, further comprising a moving substrate onto which parts are applied, the moving substrate being disposed proximal to the downstream end.

31. The external air applicator of claim 30, wherein the moving substrate comprises absorbent garment subassemblies and the parts comprise foam panels.

32. An absorbent garment comprising:
a topsheet;
a backsheet;
an absorbent core disposed between the topsheet and backsheet; and
one or more supplemental core layers assembled to the garment using the external air applicator of claim 22.

33. An absorbent garment core forming apparatus comprising:
a rotary vacuum drum having a vacuum surface;
a core forming chamber adapted to provide a supply of absorbent core material to the vacuum surface, the core forming chamber being disposed adjacent the rotary vacuum drum;
one or more air applicators disposed adjacent the rotary vacuum drum;
wherein the one or more air applicators are adapted to apply discrete parts to at least one of the vacuum surface and/or the absorbent core material.

34. An absorbent garment core forming apparatus comprising:
a rotary vacuum drum having a vacuum surface;
a supply of tissue material, the supply of tissue material being disposed on at least a portion of the vacuum surface of the rotary vacuum drum;
a core forming chamber adapted to provide a supply of absorbent core material to the supply of tissue material, the core forming chamber being disposed adjacent the rotary vacuum drum; and
one or more air applicators disposed adjacent the rotary vacuum drum;
wherein the one or more air applicators are adapted to apply discrete parts to at least one of the supply of tissue material and/or the absorbent core material.

35. An absorbent garment core forming apparatus comprising:
a rotary vacuum drum;
a core forming chamber adapted to provide a supply of absorbent core material, the core forming chamber being disposed adjacent the rotary vacuum drum; and
one or more air applicators disposed at least partially within the core forming chamber;
wherein the one or more air applicators are adapted to apply discrete parts into the core forming chamber.

36. A method for placing a series of parts onto a substrate, the method comprising: providing a series of parts to a passage having an upstream end and a downstream end opposite the upstream end;
providing an air flow to the passage, the air flow being directed towards the downstream end;
using the air flow to increase the spacing between the parts from a first spacing at the upstream end to a second spacing at the downstream end;
using the air flow to increases the velocities of the parts from a first velocity at the upstream end to a second velocity at the downstream end; and
depositing the parts, at a second spacing and a second velocity, on a substrate positioned adjacent the downstream end.

37. The method of claim 36, further comprising severing the parts from a continuous material supply as they enter the passage.

38. The method of claim 36, further comprising controlling the second speed and second spacing by modulating a pressure regulator adapted to control the pressure of air entering the one or more orifices.

39. The method of claim 38, further comprising detecting a value of at least one of the second speed and second spacing and controlling at least one of the second spacing and second velocity based on the detected value.

40. A disposable absorbent garment made according to the method of claim 36.
